(19) United States
(12) Patent Application Publication
(10) Pub. No.: US 2026/0320007 A1
(43) Pub. Date: Oct. 15, 2026

(54) COMPUTING SYSTEMS AND METHODS FOR EXTRACTING DEPENDENCY INFORMATION FROM A DATABASE

(71) Applicant: The Toronto-Dominion Bank, Toronto (CA)

(72) Inventors: Navjot Singh Aulakh, Brampton (CA); Iryna Krutiy, Mississauga (CA)

(21) Appl. No.: 19/175,720

(22) Filed: Apr. 10, 2025

(51) Int. Cl. G06F 16/21; G06F 16/2458

(52) U.S. Cl. CPC G06F 16/21; G06F 16/2458

(57) ABSTRACT

Methods, systems and software tools for extracting dependency information for one or more fields from a database. The methods comprise: receiving information identifying one or more fields in the database; in response to receiving the information, automatically retrieving, via one or more application programming interfaces (APIs), dependency information for each of the one or more fields, the dependency information for a field describing at least one of: each component in the database that depends on that field and each component in the database that the field is dependent on; and storing the retrieved dependency information in a dependency file.

### TECHNICAL FIELD

The disclosed example embodiments relate to computer-implemented methods and systems for extracting dependency information from a database.

### BACKGROUND

An enterprise may use proprietary software which stores data in a proprietary database. A “proprietary database” is a database system developed and owned by a specific company, and the company retains full control over the database's development and distribution, unlike open-source databases where the source code is publicly available. In other words, a proprietary database is a closed database with restricted access thereto.

For example, many enterprises use Salesforce®, a customer relationship management (CRM) software package, to store customer and prospect contact information, among other things, in a Salesforce® database. An enterprise does not typically have direct access to such a proprietary database (e.g., the enterprise may not be able to directly run database queries on the database) and may only access such proprietary databases through specific end-user software, web interfaces, and/or one or more APIs (application programming interfaces). For example, Salesforce® provides a web-based Salesforce® user interface which can be used to access data (e.g., records) in a Salesforce database, and a client application, called Data Loader, which can be used for the bulk import or export of data (e.g., records) in a Salesforce® database. Salesforce also provides several APIs, such as, but not limited to, a REST API, a SOAP API, and a Tooling API that can be used to import data (e.g., records) into, or export data (e.g., records) from, a Salesforce® database. Thus, the extraction of data from a proprietary database is typically achieved through such special software, web-interfaces or APIs.

### SUMMARY

The following summary is intended to introduce the reader to various aspects of the detailed description, but not to define or delimit any invention.

A first aspect provides a system for extracting dependency information for one or more fields from a database, the system comprising: a memory, a communication interface, and at least one processor operatively coupled to the memory and the communication interface; the at least one processor configured to: receive information identifying the one or more fields in the database; in response to receiving the information, automatically retrieve, via one or more application programming interfaces (APIs), dependency information for each of the one or more fields, the dependency information for a field describing at least one of: each component in the database that depends on that field and each component in the database that the field is dependent on; and store the retrieved dependency information in a dependency file.

The at least one processor may be configured to retrieve, via the one or more APIs, the dependency information for a field by querying, via the one or more APIs, a dependency object of the database.

The dependency object of the database may comprise a record for each dependency in the database, each record may identify a first component and a second component wherein the second component is dependent on the first component.

Querying, via the one or more APIs, the dependency object of the database may comprise: generating a query to search the dependency object for records in which the first component or the second component is the field; issuing the query via one or more query API requests; and retrieving results of the query via one or more result API requests.

The one or more query API requests and the one or more result API requests may be Tooling API requests.

The one or more query API requests and the one or more result API requests may be Bulk API requests.

At least one of the one or more query API requests may comprise a POST request.

At least one of the one or more result API requests may comprise a GET request.

The query may be a Salesforce Object Query Language query.

The dependency object may be a MetadataComponentDependency object.

Receiving the information identifying the one or more fields in the database may comprise: receiving a file that comprises the information, and parsing the file to determine the one or more fields.

The at least one processor may be further configured to: receive a second, different, dependency file; compare the dependency file to the second dependency file; and generate a difference file that identifies differences between the dependency file and the second dependency file.

The dependency file and the second dependency file may comprise dependency information for the one or more fields in the database at different times.

The dependency file may comprise dependency information for the one or more fields in the database and the second dependency file may comprise dependency information for the one or more fields in a second, different, database.

The at least one processor may be configured to associate the dependency file with a timestamp that indicates at least one of a date and a time at which the dependency file was generated.

The retrieved dependency information may be in a first format and storing the retrieved dependency information in the dependency file may comprise converting the retrieved dependency information to a second, different, format.

A component that depends on a field of the one or more fields and/or that the field is dependent on may be one of a flow trigger, validation rule, field set or apex class.

The database may be a proprietary database and the one or more APIs may be proprietary APIs.

A second aspect provides method for extracting dependency information for one or more fields from a database, the method comprising: receiving information identifying the one or more fields in the database; in response to receiving the information, automatically retrieving, via one or more application programming interfaces (APIs), dependency information for each of the one or more fields, the dependency information for a field describing at least one of: each component in the database that depends on that field and each component in the database that the field is dependent on; and storing the retrieved dependency information in a dependency file.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a block diagram of an example system for extracting dependency information from a database via a database dependency extraction tool;

FIG. 2 is a schematic diagram of an example graphical user interface for the database dependency extraction tool of FIG. 1;

FIG. 3 is a flow diagram of an example method for extracting dependency information from a database; and

FIG. 4 is a block diagram of an example computer which may be used to implement all or a portion of the system of FIG. 1 and/or all or a portion of the method of FIG. 3.

### DETAILED DESCRIPTION

As described above, data may be extracted from a proprietary database via proprietary software, web-interfaces and/or APIs.

A database generally comprises a set of tables each of which have a number of columns and rows. Salesforce® refers to its tables as “objects”, its rows as “records” and its columns as “fields”. Thus, a Salesforce® database has objects with fields and a number of records. The terms objects, records and fields will be used herein, however, they can be used interchangeably with the terms tables, rows and columns respectively. Furthermore, the described examples are not limited to Salesforce® databases.

A relational database is one which can establish links, or relationships, between metadata components (e.g., objects, fields etc.) in the database. Some of the relationships may be directional—i.e., one component may depend on the other component. In other words, one component references or uses the other component. An example would be a flow component that uses a specific field. In Salesforce®, such directional relationships are referred to as master-detail relationships.

Where a proprietary database is a relational database, it may be beneficial, in addition, or alternatively to being able to extract data (e.g., records) from the proprietary database, to extract the dependencies that exist for one or more fields. Such information may be useful, for example, in migrating data from a source database, to another, destination, database; in understanding the dependencies in a complex database environment; and/or in making changes to a proprietary database. Specifically, when making changes to an object or field it is important to understand the potential impact those changes may have on other components.

The special proprietary software and web interfaces which can be used to access data (e.g., records) in a proprietary database may not allow a user to extract dependency information. Accordingly, retrieving or extracting dependency information for a proprietary database may be done through one or more proprietary APIs. Accessing such information through one or more APIs requires not only for the user to know the correct API(s) to use to obtain such information but requires writing one or more lines of code. This may make obtaining this information cumbersome or difficult. Furthermore, even when such dependency information can be extracted using one or more proprietary APIs, it may not be extractable in an easily understandable format.

Accordingly, described herein are computer-implemented software tools, which may be referred to herein as database dependency extraction tools, which allow a user to easily obtain an understandable description of the dependencies for one or more fields in a proprietary database, such as, but not limited to, a Salesforce® database.

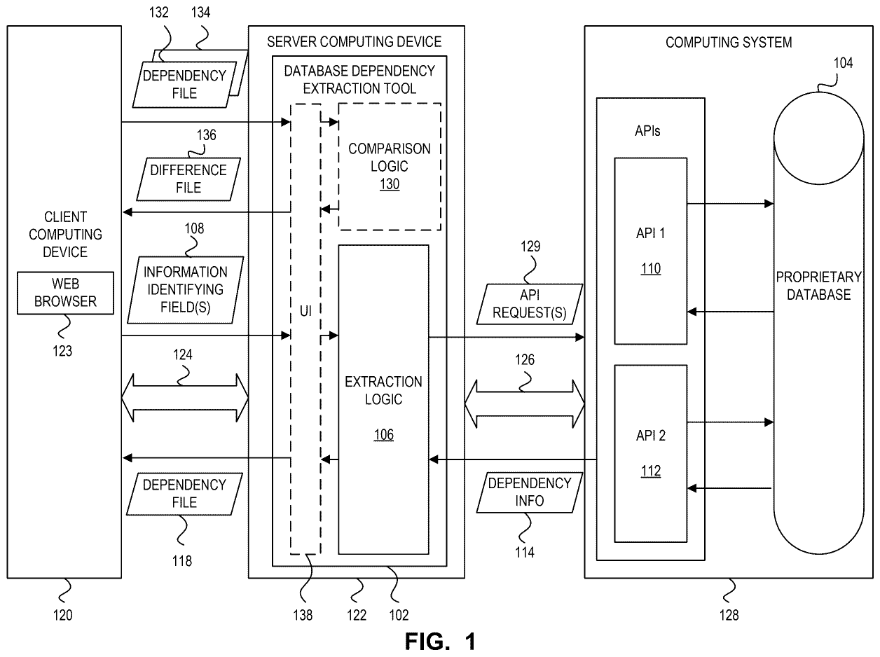

Reference is now made to FIG. 1, which illustrates an example database dependency extraction tool 102 for extracting dependency information for one or more fields of a proprietary database 104. The database dependency extraction tool 102 of FIG. 1 comprises logic 106 (e.g., software code) configured to: receive information 108 identifying a set of one or more fields in the proprietary database 104; in response to receiving the information 108, automatically retrieve, via one or more proprietary APIs 110, 112, dependency information 114 for each identified field that describes the dependencies for that field; and store the retrieved dependency information in a file 118 which is referred to herein as a dependency file.

In some cases, the information 108 identifying a set of one or more fields in the proprietary database may identify each field in the set individually. In these cases, the information identifying a specific field may be any information that uniquely identifies the field such as, but not limited, to a unique identifier (ID), or the name of the field and the table/object to which it belongs. In other cases, the information identifying a set of one or more fields in the proprietary database may identify a collection of fields—e.g., all of the fields in a table or object, or all of the fields in the database. In these cases, the information identifying a collection of fields may identify a particular database or identify a specific object or table (e.g., by a unique identifier (ID) or by name).

The information 108 identifying the set of one or more fields (for which dependency information is to be retrieved) may be received by the logic 106 in any suitable manner. For example, in some cases, a user may be able to manually enter the information 108 identifying the set of one or more fields in, for example, a user interface of the database dependency extraction tool 102. In other cases, the information 108 identifying the set of one or more fields may be stored in a file (e.g., in a predetermined format) that is uploaded, or otherwise provided, to the database dependency extraction tool 102, and specifically, the logic 106 thereof. In such cases, the logic 106 may be configured to parse the file to determine the set of one or more fields.

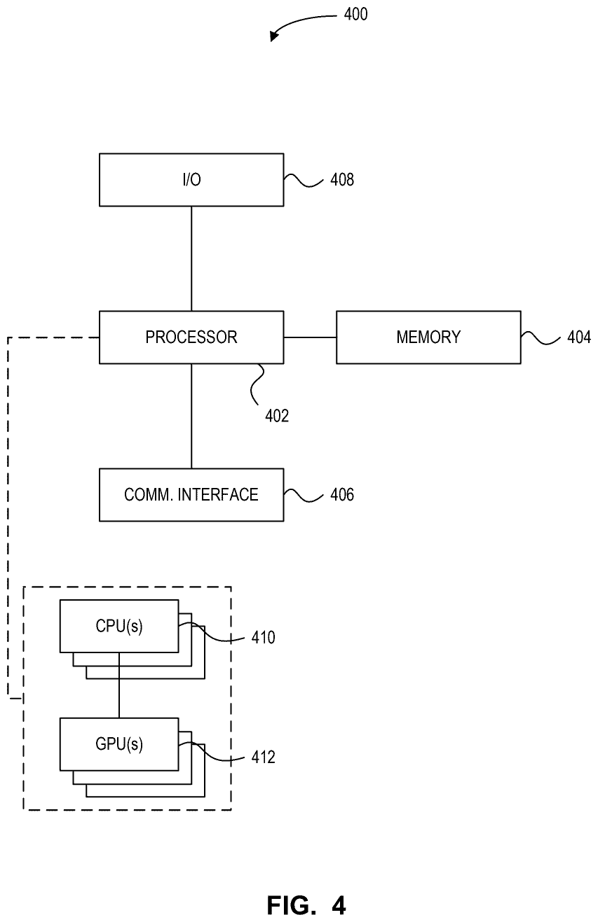

In some cases, as shown in FIG. 1, the information 108 identifying the set of one or more fields may be provided to the database dependency extraction tool 102 by a user via, for example, a client computing device 120. In some cases, as shown in FIG. 1, the database dependency extraction tool 102 may be implemented on a server computing device 122 (or the like) and the user may access the database dependency extraction tool 102, from the client computing device 120, via a communications connection 124 that connects the client computing device 120 and the server computing device 122. In such cases, the user may access the database dependency extraction tool 102 using a web browser 123, or another application, running on the client computing device 120. However, in other cases, the database dependency extraction tool 102 may be implemented on the client computing device 120 itself. In either case, the computing device that implements the database dependency extraction tool 102 (e.g., the client computing device 120 or the server computing device 122) may be connected, via a communications connection 126, to a computing system 128 that implements the proprietary APIs 110, 112 and the proprietary database 104. The computing system 128 may be implemented by one or more computing devices such as the computer 400 described below with respect to FIG. 4.

As described above, in response to receiving information 108 identifying a set of one or more fields of the proprietary database 104, the logic 106 automatically retrieves, via one or more proprietary APIs 110, 112, dependency information 114 for each identified field. The dependency information 114 for a field comprises information indicating the components in the proprietary database 104 that depend on that field and/or the components that the field depends on. In other words, the dependency information 114 for a field describes what components are using the field and/or what components the field uses. The term “component” is used herein to refer to a configuration element in the proprietary database 104 that defines the structure and/or behaviour of the proprietary database 104. Components include, but are not limited to, custom objects, fields, page layouts, workflow rules and validation rules. Where the proprietary database 104 is a Salesforce® database the components may include metadata components.

An API 110, 112 is software that allows two applications to communicate with each other using a set of definitions and protocols. APIs 110, 112 operate via requests and responses. Specifically, APIs 110, 112 receive requests and generate responses to those requests. Both requests and responses generally have a specific structure. An API request may comprise information identifying an API endpoint (i.e., a dedicated URL that provides access to a specific resource), the method (this indicates the type of operation to perform on a given resource, REST APIs are accessible through standard HTTP methods, such as GET, POST, PUT etc.), parameters (the variables that are passed to an API endpoint to provide instructions for the API), request headers (e.g. key-value pairs that provide extra details about the request), and/or a request body (this is the main part of the request and includes the data to perform the action). There are several common API architectures which include, but are not limited to, REST (REpresentational State Transfer) and SOAP (Simple Object Access Protocol). Both SOAP and REST describe rules and standards on how applications make, process, and respond to requests. They both use HTTP to exchange information, and they both support SSL/TLS for secure, encrypted communication. However, SOAP defines rigid communications rules and there are standards that control every aspect of the data exchange. REST was developed after SOAP and solves many of the issues therewith.

The logic 106 may be configured to automatically retrieve the dependency information 114 for each identified field by automatically generating one or more API requests 129 to retrieve the dependency information for the identified fields; sending the generated API requests 129 to the appropriate APIs 110, 112; and receiving the dependency information 114 for each identified field in one or more responses. By automatically generating the API request(s) 129, the user does not need to know (i) the structure of the proprietary database 104 and where dependency information is stored, (ii) which APIs are relevant, and (iii) how to generate API requests.

In some cases, the proprietary database 104 may comprise a special object, referred to as a dependency object, that is used by the proprietary database 104 to store dependency information. The dependency object may comprise a record for each dependency in the proprietary database 104 that identifies a first object and a second object wherein the second object is dependent on the first object. In these cases, the logic 106 may be configured to retrieve the dependency information 114 for an identified field by querying the dependency object for the dependency records that relate to that field. This may comprise generating one or more query API requests which cause an API to (1) search the dependency object of the proprietary database 103 for records in which the first and second objects are the field and (2) return the results of the query as the dependency information.

For has a example, a Salesforce® database MetadataComponentDependency object. The MetadataComponentDependency object is a special object that stores dependency information in records. Specifically, each record of the MetadataComponentDependency object represents a dependency between two metadata components (e.g., objects, fields, etc.) in Salesforce®. Each row is a directional dependency so if two components, A and B, are dependent on each other, there will be a record that describe that B is dependent on A, and another record that describes that A is dependent on B.

Dependencies that relate to a specific component can be retrieved or identified by querying (via an SOQL (Salesforce Object Query Language) query) the MetadataComponentDependency object. In Salesforce® the MetadataComponentDependency object can be queried using the Tooling API or Tooling API endpoints in the Bulk API. The Tooling API exposes metadata in a Salesforce® database that can be accessed through a REST or SOAP interface. The Tooling API is designed to provide fine-grained access to the metadata of a database and allows smaller pieces of metadata to be retrieved. The Bulk API is a RESTful API designed to provide a simple interface to load large amount of data into a Salesforce® database and perform bulk queries on the database. Using Bulk API one can can query the MetadataComponentDependency object and retrieve up to 100,000 records in a single query.

For either the Tooling API or the Bulk API, a query job can be created by issuing a REST API (or SOAP API) POST request that includes the SOQL query statement in the body of the request. The SOQL query statement identifies (i) the metadata component of interest (e.g., via the component ID, type etc.), (ii) the object that is being querying (i.e., MetadataComponentDependency), and (iii) the fields of the matching records that are to be returned.

Specifically, each record in the MetadataComponentDependency object may comprise, at least, the fields shown in Table 1. As can be seen in Table 1, each record comprises fields related to a master component and fields related to a dependent or detail component wherein the dependent or detail component is dependent on the master component. In the example shown in Table 1, there is a component ID, component name, component namespace and component type field for each of the master component and the dependent or detail component.

TABLE 1

| | Field | Description |
|---|---|---|
| Dependent or | MetadataComponentID | The ID of a metadata |
| Detail Component | | component that is |
| | | dependent on another |
| | | component. |
| | | This is a string field that |
| | | usually contains either an |
| | | 18-character ID or a |
| | | standard object name. |
| | MetadataComponentName | The name of a metadata |
| | | component that depends |
| | | on another component. |
| | | This is a string field |
| | MetadataComponentNamespace | The namespace of a |
| | | component that depends |
| | | on another component. |
| | | This is a string field. |
| | MetadataComponentType | The type of a metadata |
| | | component that depends |
| | | on another component. |
| | | This is a string field. |
| Master Component | RefMetadataComponentID | The ID of a metadata |
| | | component that another |
| | | component depends on. |
| | | This is a string field that |
| | | usually contains either an |
| | | 18-character ID or a |
| | | standard object name. |
| | RefMetadataComponentName | The name of a metadata |
| | | component that another |
| | | component depends on. |
| | | This is a string field. |
| | RefMetadataComponentNamespace | The namespace of a |
| | | metadata component that |
| | | another component |
| | | depends on. |
| | | This is a string field. |
| | RefMetadataComponentType | The type of metadata |
| | | component that another |
| | | component depends on. |
| | | This is a string field. |

Where the MetadataComponentDependency object has the fields shown in Table 1, the components that are dependent on a specific component may be identified by performing a search in the MetadataComponentDependency object for records where “RefMetadataComponentID” is set to the ID of that specific component and then requesting that any combination of the MetadataComponentID, MetadataComponentName, MetadataComponentNamespace and MetadataComponentType fields from the identified records are returned.

For example, the following is an example SOQL query to identify all the metadata components (and specifically the names and typed thereof) that are dependent on a metadata component with the ID “yourFieldID”. Specifically, the WHERE clause filters a query.
SELECT MetadataComponentName, MetadataComponentType
   FROM MetadataComponent Dependency
   WHERE RefMetadataComponentID=yourFieldId

An example REST API POST request that includes the above SOQL query is shown below. In response to issuing the POST request, the requestor receives information about the request including a query job ID.

```
curl --include --request POST \
--data ′{
  ″operation″: ″query″,
″query″: ″SELECT MetadataComponentName, MetadataComponentType
  FROM MetadataComponentDependency WHERE RefMetadataComponentID =
  yourFieldId “
}′ \
″https://instance.salesforce.com/services/data/v49.0/tooling/jobs/qu
ery″
```

Once the query job has been completed, the results of the query can be obtained by issuing a REST API (or SOAP API) GET request that identifies the query (e.g., by query job ID). The query results include a row for each identified dependency relationship.

The dependencies may include, for example, dependencies based on validation rules, flow triggers, field sets, and apex classes. Validation rules are used to verify that the data a user enters in a record matches specified standards (e.g., a validation rule can contain a formula or expression that evaluates the data in or more fields and returns a value of “True” or “False”). Flow triggers allow actions to automatically be performed in Salesforce® behind the scenes in response to an action (e.g., a flow trigger can cause something to be triggered (e.g., the creation of a new record in a different object) when a record is created in a first object). Thus, the results of the query may indicate the impact of disabling a certain flow trigger. A field set is a grouping of fields (e.g., a field set may describe a user's first name, middle name, last name and business title). An apex class is a template or blueprint class from which other objects are created.

Accordingly, where the proprietary database is a Salesforce® database the logic 106 may be configured to retrieve the dependency information for an identified field by generating an SOQL query to query the MetadataComponentDependency object for components that are dependent on and/or depend on that field; issuing the query via the Tooling API or the Bulk API, via, for example, a POST request; and retrieving the results of the issued query, via, for example, a GET request. This is just an example of how the logic 106 may obtain dependency information for a field in a proprietary database, such as a Salesforce® database, and in other examples, the logic 106 may be configured to obtain the dependency information for a field in a proprietary database in another manner.

As described above, the logic 106 is configured to store the received dependency information for each identified field in a dependency file 118. In some cases, the dependency file 118 may be an electronic document in which data is arranged in the rows and columns of a grid (e.g., a spreadsheet). In some cases, the logic 106 may receive the dependency information 114 for a field in one form or format and may convert the received dependency information 114 into another form or format. For example, in some cases the logic 106 may receive the dependency information 114 for a field in CSV (comma-separated values) format and convert the received information from CSV format to a spreadsheet format (e.g., Microsoft® Excel® format).

Having access to the dependency information for a set of fields may make it easier for users to visualize the interconnections between different components and fields, offering a better overall understanding of how data flows through the proprietary database 104. This information can be invaluable when working on complex projects involving multiple integrations, customizations and configurations.

The generated dependency file 118 can also be shared with team members and/or stakeholders, enabling better communication and collaboration on projects, as everyone has access to accurate and up-to-date representation of the proprietary database environment.

In some cases, the logic 106 may be configured to timestamp the generated dependency file 118 with the time and/or date at which it was generated. This may be useful to determine if there have been any changes in relation to the dependencies of the identified fields after the dependency file 118 was generated.

In some cases, the database dependency extraction tool 102 may also comprise comparison logic 130 (e.g., software code) that is configured to receive two different dependency files 132, 134 (each generated by the database dependency extraction tool 102); compare the provided dependency files; and generate and output a difference file 136 setting out the differences between the two dependency files 132, 134—e.g., any additions, deletions or changes of dependencies. In some cases, the difference file 136 may be an electronic document in which data is arranged in the rows and columns of a grid (e.g., a spreadsheet).

The comparison logic 130 can be used to compare two dependency files that were generated for the same set of fields in the same database on different dates and/or at different times to determine what changes have been made since the original (i.e., older) dependency file was generated.

The comparison logic 130 can alternatively be used to compare dependency files generated for the same set of fields from different databases to identify differences in the dependency configuration of the two databases. This may be useful in migrating data from one database to another. For example, if data is to be extracted from a source database and migrated to a destination database it may be desirable to ensure that the fields that are being migrated have the same dependencies in the source and destination databases reducing the risk of data inconsistencies during data migration. This information may also, or alternatively, be used to identify differences between the configuration of two different databases to efficiently identify changes to be made to one database or the other. This may allow changes to be implemented systematically, minimizing errors and reducing the time for deployments.

In some cases, the database dependency extraction tool 102 may be implemented by a Python script.

In some cases, as shown in FIG. 1, the database dependency extraction tool 102 may comprise a user interface (UI) 138 (e.g., a graphical user interface) which allows a user to identify the one or more fields. In some cases, the UI 138 may also allow the user to specify where the generated dependency file is to be stored. Where the database dependency extraction tool 102 comprises comparison logic 130, the UI 138 may also provide a mechanism for the user to provide the dependency files 132, 134 for comparison to the comparison logic 130 and initiate the comparison. In these cases, the UI 138 may also allow the user to specify where the generated difference file 136 is to be stored.

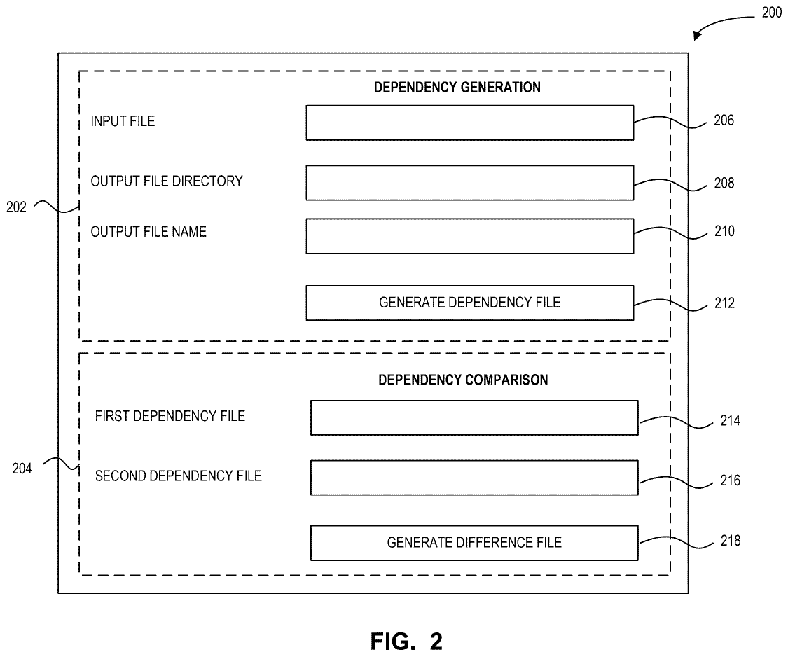

Reference is now made to FIG. 2 which illustrates an example graphical user interface 200 which may be used to implement the UI 138 of FIG. 1. The example graphical user interface 200 comprises a dependency generation section 202 and a dependency comparison section 204. The dependency generation section 202 allows a user to: identify a file which identifies the one or more fields of the proprietary database 104 for which dependency information is to be obtained; identify the location (e.g., folder) in which the generated dependency file is to be stored; identify the name of the generated dependency file; and initiate the generation of the dependency file comprising the dependency information for the identified fields.

The example dependency generation section 202 of FIG. 2 comprises: a first text field 206 in which the user can enter information (e.g., a folder path and file name) identifying a file that comprises information identifying the one or more fields of the proprietary database 104 for which dependency information is to be stored; a second text field 208 which allows the user to enter information (e.g., a folder path) identifying a location where the generated dependency file is to be stored; a third text field 210 which allows the user to enter information (e.g., a file name) identifying a name of the generated dependency file; and a button 212, which the user can click, or otherwise activate, to initiate the retrieval of the dependency information for the identified field(s) and the generation of the dependency file based thereon.

The dependency comparison section 204 allows a user to: identify a first dependency file; identify a second dependency file; and initiate a comparison of the identified first and second dependency files and the generation of a difference file based on the comparison. The example dependency comparison section 204 shown in FIG. 2 comprises: a first text field 214 in which the user can enter information (e.g., a folder path and file name) identifying a first dependency file to be compared; a second text field 216 in which the user can enter information (e.g., a folder path and file name) identifying a second dependency file to be compared; and a button 218 which the user can click, or otherwise activate, to initiate a comparison of the identified first and second dependencies files and the generation of a difference file based on the comparison.

### Method

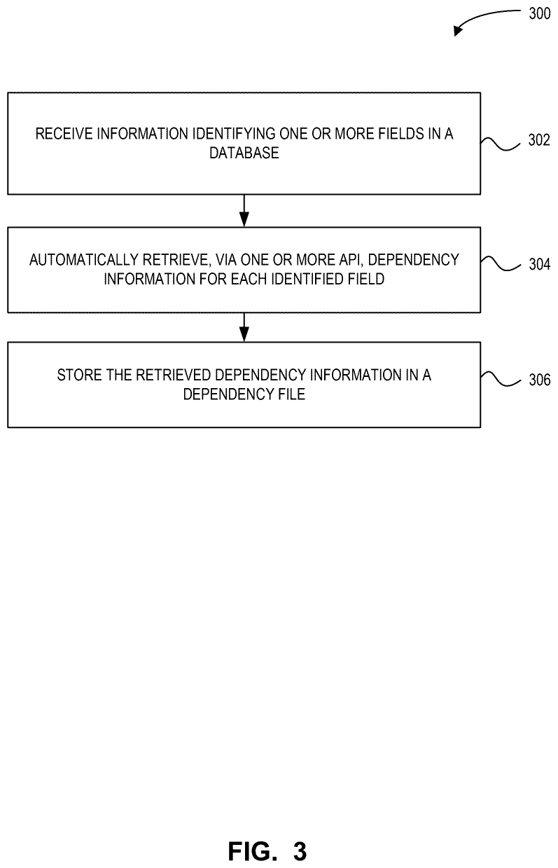

Reference is now made to FIG. 3 which illustrates an example method 300 for extracting dependency information for a set of one or more fields of a proprietary database, which may, for example, be implemented by the database dependency extraction tool 102 of FIG. 1. The method 300 begins at block 302 where information identifying a set of one or more fields in the proprietary database is received. In some cases, the information identifying a set of one or more fields in the proprietary database may identify each field in the set individually. For example, the information may comprise a unique identifier or a name and table/object for each field in the set. In other cases, the information identifying a set of one or more fields in the proprietary database may identify a collection of fields, such as, but not limited to, all the fields in a database or all the fields in a table/object. For example, the information may comprise information (e.g., a unique identifier (ID) or name) identifying a particular database or object or table. In some cases, the information identifying the set of one or more fields may be stored in a file having a predetermined format. In such cases, the method may further comprise parsing the file to determine the set of one or more fields. Once the information identifying the set of one or more fields in the proprietary database has been received, the method 300 proceeds to block 304.

At block 304, in response to receiving the information identifying a set of one or more fields in the proprietary database, dependency information for each identified field is automatically retrieved, via one or more proprietary APIs. The dependency information for a field describes each component in the proprietary database that depends on that field and/or that the field is dependent on. As described above, the term “component” is used herein to refer to a configuration element in the proprietary database that defines the structure and/or behaviour of the proprietary database. Components include, but are not limited to, custom objects, fields, page layouts, workflow rules and validation rules.

In some cases, the dependency information for a field may be retrieved by querying, via one or more proprietary APIs, a dependency object of the proprietary database, such as the MetadataComponentDependency object in a Salesforce® database. The dependency object comprises a record for each dependency in the database. Each record identifies a first component and second component wherein the second component is dependent on the first component. In some cases, retrieving the dependency information for a field by querying, via one or more APIs, the dependency object may comprise generating a query to search the dependency object for records in which the first or second component is the field; issuing the query via one or more query API requests; and retrieving results of the query via one or more result API requests. The one or more query API requests may comprise one or more POST requests and the one or more result API request may comprise one or more GET requests. Where the proprietary database is a Salesforce® database, the query may be an SOQL query. Example SOQL queries were provided above. Where the proprietary database is a Salesforce® database, the one or more query API requests and the one or more result API requests may be Tooling API requests or Bulk API requests.

Once the dependency information for the identified field(s) has been retrieved, the method 300 proceeds to block 306.

At block 306, the retrieved dependency information is stored in a dependency file. In some cases, the dependency file is a spreadsheet (e.g., a Microsoft® Excel® file). In some cases, the dependency information is in a first format (e.g., CSV format) and the dependency file is in a second, different, format (e.g., spreadsheet format). In such cases, storing the retrieved dependency information in the dependency file may comprise converting the received dependency information from the first format to the second format. In some cases, storing the retrieved dependency information in a dependency file further comprises associating the dependency file with a timestamp that indicates a date and/or time at which the dependency file was generated. As described above, this information may be used to determine which of two dependency files for the same set of one or more fields of a proprietary database was generated first. After the retrieved dependency information is stored in the dependency file, the method 300 may end.

In some cases, the method may further comprise receiving a second, different, dependency file; comparing the dependency file to the second dependency file; and generating a difference file (e.g., a spreadsheet) that identifies differences between the dependency file and the second dependency file. In some cases, the original dependency file and the second dependency file both comprise dependency information for the one or more fields in the proprietary database at different times. In other cases, the dependency file comprises dependency information for the one or more fields in the proprietary database and the second dependency file comprises dependency information the one or more fields in a second, different, proprietary database.

Although the example systems, methods and tools described above for extracting dependency information from a database are described as being designed for a proprietary database, the systems, methods and tools described herein can be used to extract dependency information from any database that is accessible via one or more APIs.

### Example Computer

Reference is now made to FIG. 4 which illustrates a simplified block diagram of an example computer 400. Computer 400 is an example implementation of a computer which may implement all or a portion of the client computing device 120 of FIG. 1, the server computing device 122 of FIG. 1, the computing system 128 of FIG. 1 and/or the method 300 of FIG. 3. Computer 400 has at least one processor 402 operatively coupled to at least one memory 404, at least one communications interface 406 (also referred to herein as a network interface), and at least one input/output (I/O) device 408.

The at least one memory 404 includes a volatile memory that stores instructions executed or executable by the processor 402, and input and output data used or generated during execution of the instructions. The memory 404 may also include non-volatile memory used to store input and/or output data—e.g., within a database—along with program code containing executable instructions.

The processor 402 may transmit or receive data via the communications interface 406 and may also transmit or receive data via any additional input/output device 408 as appropriate.

In some cases, the processor 402 includes a system of central processing units (CPUs) 410. In other cases, the processor 402 includes a system of one or more CPUs 410 and one or more Graphical Processing Units (GPUs) 412 that are coupled together.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

1. A system for extracting dependency information for one or more fields from a database, the system comprising:
a memory, a communication interface, and at least one processor operatively coupled to the memory and the communication interface;
the at least one processor configured to:
receive information identifying the one or more fields in the database;
in response to receiving the information, automatically retrieve dependency information for each of the one or more fields by querying, via one or more application programming interfaces (APIs), a dependency object of the database that comprises a record for each dependency in the database that identifies a first component and a second component wherein the second component is dependent on the first component, the dependency information for a field describing at least one of: each component in the database that depends on that field and each component in the database that the field is dependent on; and
store the retrieved dependency information in a dependency file.

2. (canceled)

3. (canceled)

4. The system of claim 1, wherein querying, via the one or more APIs, the dependency object of the database comprises:
generating a query to search the dependency object for records in which the first component or the second component is the field;
issuing the query via one or more query API requests; and
retrieving results of the query via one or more result API requests.

5. The system of claim 4, wherein the one or more query API requests and the one or more result API requests are Tooling API requests.

6. The system of claim 4, wherein the one or more query API requests and the one or more result API requests are Bulk API requests.

7. The system of claim 4, wherein at least one of the one or more query API requests comprises a POST request.

8. The system of claim 4, wherein at least one of the one or more result API requests comprises a GET request.

9. The system of claim 4, wherein the query is a Salesforce Object Query Language query.

10. The system of claim 1, wherein the dependency object is a MetadataComponentDependency object.

11. The system of claim 1, wherein receiving the information identifying the one or more fields in the database comprises:
receiving a file that comprises the information, and
parsing the file to determine the one or more fields.

12. The system of claim 1, wherein the at least one processor is further configured to:
receive a second, different, dependency file;
compare the dependency file to the second dependency file; and
generate a difference file that identifies differences between the dependency file and the second dependency file.

13. The system of claim 12, wherein the dependency file and the second dependency file comprise dependency information for the one or more fields in the database at different times.

14. The system of claim 12, wherein the dependency file comprises dependency information for the one or more fields in the database and the second dependency file comprises dependency information for the one or more fields in a second, different, database.

15. The system of claim 1, wherein the at least one processor is configured to associate the dependency file with a timestamp that indicates at least one of a date and a time at which the dependency file was generated.

16. The system of claim 1, wherein the retrieved dependency information is in a first format and storing the retrieved dependency information in the dependency file comprises converting the retrieved dependency information to a second, different, format.

17. The system of claim 1, wherein a component that depends on a field of the one or more fields and/or that the field is dependent on is one of a flow trigger, validation rule, field set or apex class.

18. The system of claim 1, wherein the database is a proprietary database and the one or more APIs are proprietary APIs.

19. A method for extracting dependency information for one or more fields from a database, the method comprising:
receiving information identifying the one or more fields in the database;
in response to receiving the information, automatically retrieving dependency information for each of the one or more fields by querying, via one or more application programming interfaces (APIs), a dependency object of the database that comprises a record for each dependency in the database that identifies a first component and a second component wherein the second component is dependent on the first component, the dependency information for a field describing at least one of: each component in the database that depends on that field and each component in the database that the field is dependent on; and
storing the retrieved dependency information in a dependency file.

20. A non-transitory computer readable medium storing computer executable instructions which, when executed by at least one computer processor, cause the at least one computer processor to carry out a method for extracting dependency information for one or more fields from a database, the method comprising:
receiving information identifying the one or more fields in the database;
in response to receiving the information, automatically retrieving dependency information for each of the one or more fields by querying, via one or more application programming interfaces (APIs), a dependency object that identifies a first component and a second component wherein the second component is dependent on the first component of the database that comprises a record for each dependency in the database, the dependency information for a field describing at least one of: each component in the database that depends on that field and each component in the database that the field is dependent on; and
storing the retrieved dependency information in a dependency file.

21. The system of claim 1, wherein the at least one processor is further configured to present a graphical user interface and the information identifying the one or more fields in the database is received via the graphical user interface.

22. The system of claim 14, wherein the at least one processor is further configured to identify changes to be made to the database or the second database based on the difference file.
